(19) United States
(12) Patent Application Publication
(10) Pub. No.: US 2014/0009982 A1
(43) Pub. Date: Jan. 9, 2014

(54) FEEDBACK CONTROL CIRCUIT FOR POWER CONVERTER AND POWER CONVERTER SYSTEM

(71) Applicants: Zhengrong Li, Taoyuan Hsien (TW); Bin Wang, Taoyuan Hsien (TW); Shouyan Wang, Taoyuan Hsien (TW); Hongyang Wu, Taoyuan Hsien (TW); Wentao Zhan, Taoyuan Hsien (TW)

(72) Inventors: Zhengrong Li, Taoyuan Hsien (TW); Bin Wang, Taoyuan Hsien (TW); Shouyan Wang, Taoyuan Hsien (TW); Hongyang Wu, Taoyuan Hsien (TW); Wentao Zhan, Taoyuan Hsien (TW)

(73) Assignee: DELTA ELECTRONICS, INC., Taoyuan Hsien (TW)

(21) Appl. No.: 13/741,222

(22) Filed: Jan. 14, 2013

(30) Foreign Application Priority Data
Jul. 5, 2012 (CN) 201210231658.4

(51) Int. Cl. H02M 1/14; G05F 1/10

(52) U.S. Cl. CPC H02M 1/14; G05F 1/10
USPC 363/40; 323/234

(57) ABSTRACT

A feedback control circuit for a power converter and a power converter system, includes a sampling network, configured to sample an input or output of the power converter, and output a first sampled signal; a filtering network, configured to receive the first sampled signal and output a second sampled signal, the filtering network filtering a ripple signal at a preset frequency out from the first sampled signal, so as to remain signals therein outside the preset frequency, while maintaining a phase delay between the second sampled signal and the first sampled signal within a preset range; a control and drive circuit, configured to receive the second sampled signal, and regulate in accordance with the second sampled signal a control signal outputted from the control and drive circuit to the power converter.

### CROSS REFERENCE TO RELATED APPLICATIONS

The present application claims priority under 35 U.S.C. §119 to Chinese Patent Application No. 201210231658.4, filed on Jul. 5, 2012, the entire content of which is incorporated herein by reference.

### TECHNICAL FIELD

This application relates to a feedback control circuit for a power converter and a power converter system.

### BACKGROUND

With the rapid development and increasing maturity of power converter technology, a variety of power converter capable of converting electrical currents emerges to be used for the conversion and control of high-power electrical energy, such as the active power filter (APF), static var generator (SVG), Uninterruptible Power Systems (UPS), inverters, switching power supplies, and so on, which are applied in the power and electronic devices.

A power converter system in general consists of a power converter and a feedback control circuit. The feedback control circuit consists of a sampling network and a control and drive circuit. Depending on its application, the power converter system may be implemented as AC inverter system or DC conversion system. FIG. 1 shows a conventional power converter system in which the power converter is implemented as an inverter. In the conventional power converter system, a sampling network of a feedback control circuit samples an output of the inverter, and a control and drive circuit regulates, based on the sampled signal outputted from the sampling network, a control signal that is outputted to the power converter. FIG. 2 shows another type of conventional power converter system in which the power converter comprises a rectifier circuit and a DC converter. In this conventional power converter system, a sampling network of a feedback control circuit samples an input of the DC converter, a control and drive circuit regulates, in accordance with the sampled signal outputted from the sampling network, a control signal that is outputted to the DC converter.

Therefore, as may be seen from FIGS. 1 and 2, in the power converter system, the sampling network in the feedback control circuit may sample the input of the power converter, or may sample the output of the power converter. In either case, usually there are high-frequency ripple interferences in the signals outputted from the sampling network. Such interferences may originate from switching elements in the power conversion, and may also originate from other sources. In general, these high-frequency interference ripples may give a negative effect on sampling accuracy of the sampling network in the feedback control circuit, or lead to a poor control accuracy of the feedback control circuit.

### SUMMARY OF THE INVENTION

This application, in part, proposes a feedback control circuit for a power converter and a power converter system, which is capable of improving sampling accuracy of the feedback control circuit, or optimizing control effect over the power converter by the feedback control circuit.

According to a first aspect of this application, it is provided a feedback control circuit for a power converter comprising: a sampling network, for sampling an input of the power converter or an output of the power converter, and outputting a first sampled signal; a filtering network, for receiving the first sampled signal and outputting a second sampled signal, the filtering network filtering a ripple signal at a preset frequency out from the first sampled signal, so as to remain signals in the first sampled signal outside the preset frequency, while maintaining a phase delay of the second sampled signal relative to the first sampled signal within a preset range; and a control and drive circuit, for receiving the second sampled signal, and regulating in accordance with the second sampled signal a control signal that is to be outputted from the control and drive circuit to the power converter.

According to a second aspect of this application, it is provided a power converter system comprising: a power converter, for performing electrical energy conversion; and a feedback control circuit as described above, being connected to the power converter, for regulating an input of the power converter or an output of the power converter.

This application, partly, may improve the sampling accuracy of the feedback control circuit, or optimize the control over the power converter by the feedback control circuit.

### BRIEF DESCIRPTION OF THE DRAWINGS

FIG. 1 is a schematic diagram of an AC inverter system using conventional technology;

FIG. 2 is a schematic diagram of a DC converter system using conventional technology;

FIG. 3 is a block diagram of a power converter system comprising a low-pass RC filtering network;

FIG. 4 is a graph illustrating a sampling by a low-order or small-parameter low-pass RC filtering network;

FIG. 5 is a graph illustrating a sampling by a high-order or large-parameter low-pass RC filtering network;

FIG. 6 illustrates a comparison between Bode plots of the low-order or small-parameter low-pass RC filtering network and that of the high-order or large-parameter low-pass RC filtering network;

FIG. 7 is a schematic block diagram of a feedback control circuit for a power converter according to the first aspect of this application;

FIG. 8 is a schematic block diagram of a feedback control circuit, where the filtering network shown in FIG. 7 acts as a passive notch filter;

FIG. 9 is a schematic diagram illustrating a specific structure of the passive notch filter shown in FIG. 8;

FIG. 10 illustrates Bode plots of the passive notch filter shown in FIG. 9;

FIG. 11 is a schematic block diagram of a feedback control circuit, where the filtering network shown in FIG. 7 acts as an active band-stop filter;

FIG. 12 is a schematic diagram illustrating a specific structure of the active band-stop filter shown in FIG. 11;

FIG. 13 illustrates Bode plots of the active band-stop filter shown in FIG. 12;

FIG. 14 is a schematic block diagram of a feedback control circuit, where the filtering network shown in FIG. 7 acts as a digital notch filter;

FIG. 15 is a schematic diagram of a power converter system according to the second aspect of the present application.

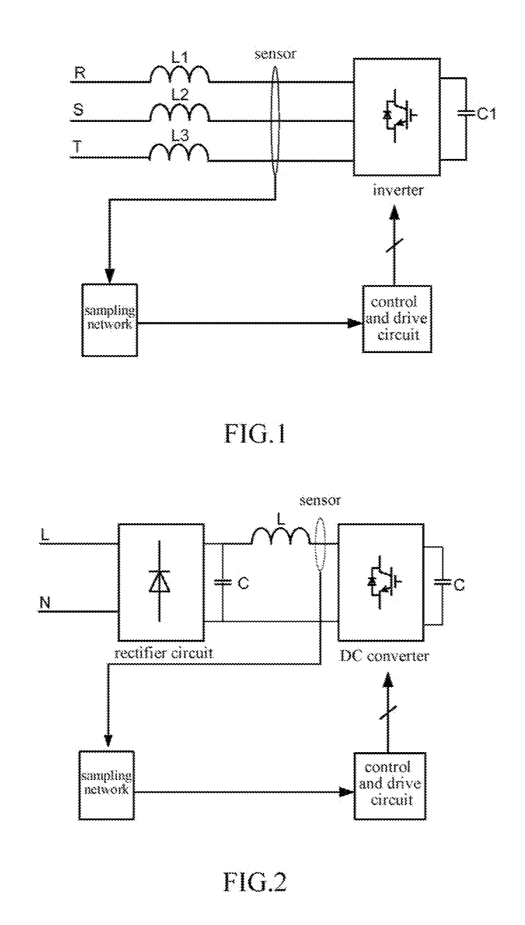

### DESCIRPTION OF THE EMBODIMENTS

Embodiments of the present application will be described in detail hereinbelow with reference to the figures. It should be noted that the embodiments described here is for illustrative purposes only and is not used to limit the present application.

The first aspect of the present application discloses a feedback control circuit for a power converter, and the content given below is for helping understand the feedback control circuit for the power converter disclosed by the first aspect.

In order to suppress the high frequency ripples in the power converter system, a filter may be additionally provided at an input end or an output end of the power stage (the power converter side). However, the inventors notice that, in a case where the sampled signal obtained from the input/output side of the power converter is modulated in the manner of PWM, usually there are switching level high-frequency ripples at the control level (the control and drive circuit side). Nevertheless, the switching level high-frequency ripples may not be filtered out targetedly by the filter provided at the power stage.

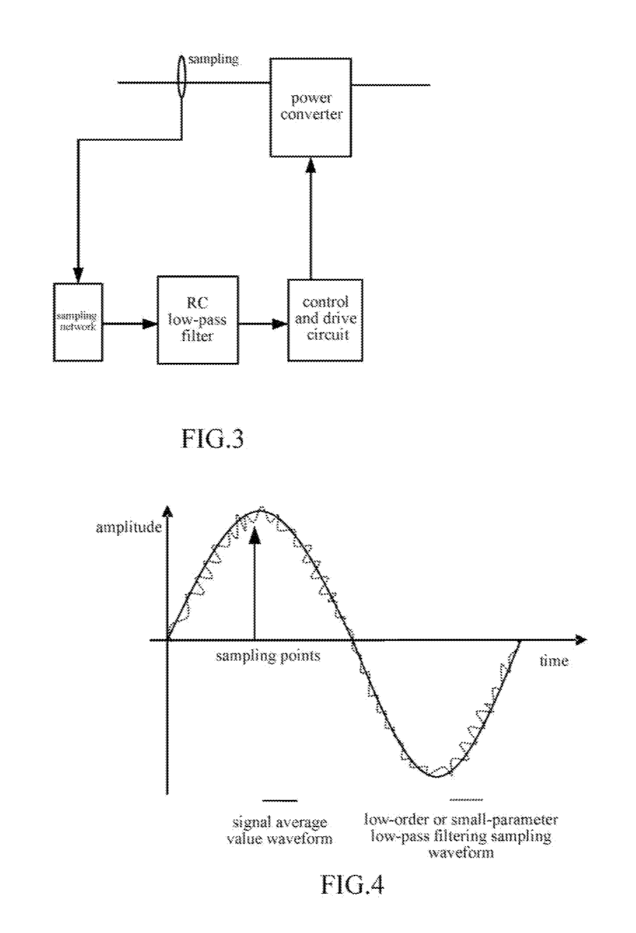

Therefore, in order to improve sampling accuracy of the control level, a RC low-pass filter may be additionally provided at the control level (for example, between the sampling network and the control and drive circuit in the feedback control circuit), as shown in FIG. 3. However, a low-order or small-parameter RC low-pass filter has poor suppression effect on high frequency ripples at switching frequency, thus sampling error may still exist because of its disturbance, as shown in the diagram of FIG. 4 illustrating a sampling by the low-order or small-parameter low-pass RC filtering network.

In order to increase the suppression effect on high frequency ripples at switching frequencies, it is desired to increase the values of parameters of the RC low-pass filter or increase the order of the filtering network. Although such a high-order or large-parameter RC low-pass filter increases attenuation degree at the high frequency band, meanwhile, the phase delay of the useful signal at low frequency band are also increased. This will also lead to sampling error, as shown in the diagram of FIG. 5 illustrating a sampling by the high-order or large-parameter low-pass RC filtering network.

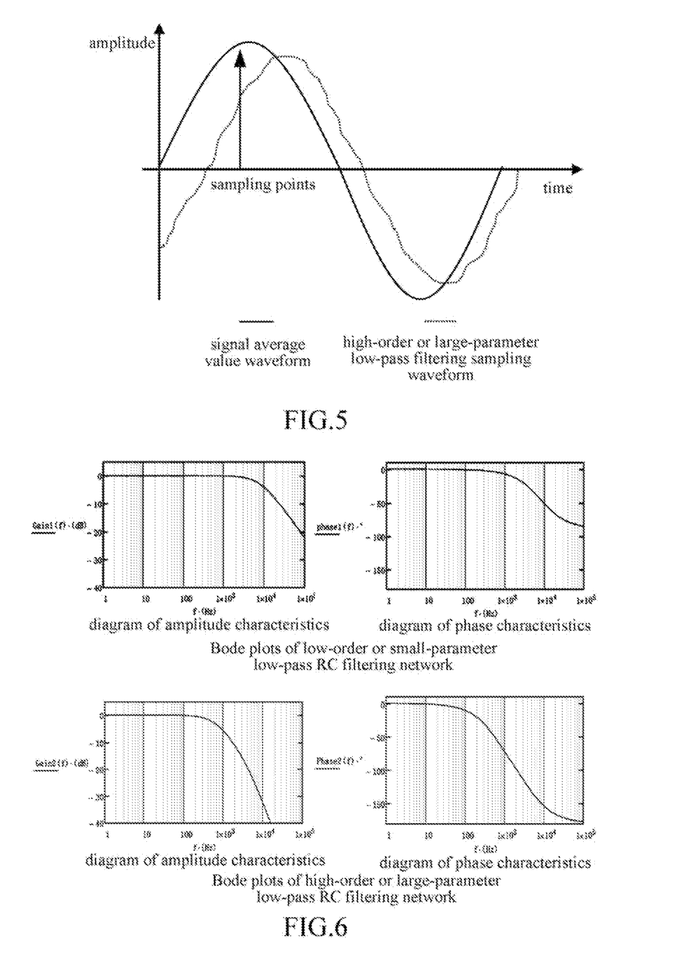

Referring to FIG. 6, by comparing Bode plots of the low-order or small-parameter low-pass RC filtering network with Bode plots of the high-order or large-parameter low-pass RC filtering network, it may be seen that the cutoff frequency of the low-order or small-parameter RC filter is higher, and the attenuation of the amplitude at high frequency is smaller (i.e., worse effect of suppression on high frequency), while the phase delay is smaller. In contrast, the cutoff frequency of the higher-order RC low-pass filter is lower, and the attenuation of the amplitude at high frequency is larger (i.e., better effect of suppression on high frequency), while the phase delay is larger.

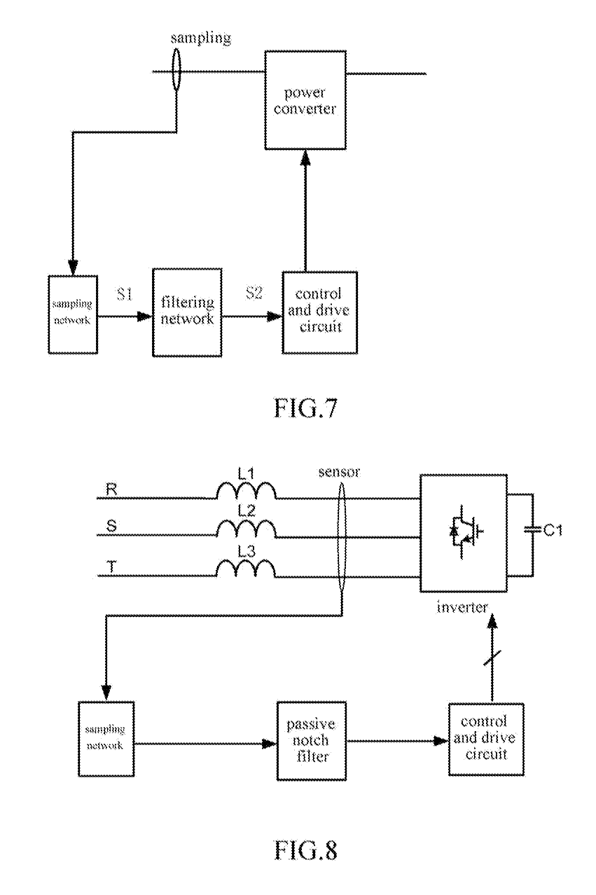

In order to overcome the problems both in the low-order or small-parameter RC low-pass filter and the high-order or large-parameter RC low-pass filter, as shown in FIG. 7, it is provided a feedback control circuit for a power converter comprising a sampling network, a filtering network and a control and drive circuit. The sampling network is configured to sample an input or an output of the power converter to obtain a first sampled signal S1; the filtering network is configured to perform filtering to the first sampled signal S1 so as to obtain a second sampled signal S2, wherein, the filtering network may be configured to filter a ripple signal at a preset frequency out from the first sampled signal S1 so as to remain signals in the first sampled signal S1 outside the preset frequency, while maintaining a phase delay of the second sampled signal S2 relative to the first sampled signal S1 within a preset range; the control and drive circuit is configured to receive the second sampled signal S2, and regulate its output signal (a control signal) to the power converter in accordance with the second sampled signal S2. The control and drive circuit may comprise two parts: a PWM control unit and a drive circuit for the power converter. The PWM control unit is configured to receive the second sampled signal S2, and perform PWM modulation to its received signal, then feed it back to the power converter via the drive circuit.

A filtering network is additionally provided between the sampling network and the control and drive circuit of the feedback control circuit as shown in FIG. 7. The filtering network may be configured to realize that, while keeping the phase delay of the signal within a small range, it is also able to filter the ripple signal at the preset frequency out from the first sampled signal S1 in a fairly well manner, so as to remain signals in the first sampled signal outside the preset frequency. The RC low-pass filter shown in FIG. 3 may be configured to filter out all of the signals (including the ripple signal at the preset frequency) that are at frequencies higher than a specific frequency, however, the filtering network shown in FIG. 7 differs from the RC low-pass filter in that, while filtering out the ripple signal at the preset frequency, the filtering network may remain the signals outside the preset frequency, and meanwhile, there is not any relatively large phase delay.

The ripple signal at the preset frequency may be a ripple signal at a switching level frequency, or may be ripple signals at the switching level frequency and at frequencies close thereto. For a person skilled in the art, the ripple signal at the switching level frequency should be interpreted as a ripple signal at the switching frequency or a ripple signal at a frequency being integer multiplies of the switching frequency.

According to interference signals existing in the power converter's output/input which is actually sampled by the sampling network, in the specific situation of practical applications, it is allowed to filter out the ripple signal at the switching frequency only, or to filter out the ripple signals at frequencies above twice the switching frequency only, or to filter out both of them. In some other cases, there is also need to filter out signals at frequencies being other multiples of the switching frequency. In such a case, signals to be filtered out are chosen as those interfering signals that usually have larger impact on the sampling accuracy of the sampling network relative to interfering signals at other frequencies. Therefore, other possible cases related to the preset frequency would not be enumerated herein.

The filtering network in the feedback control circuit disclosed in the first aspect of this application may realize the following filtering effect: the amplitude of ripple signal at the preset frequency in the second sampled signal S2 output by the filtering network is attenuated to one-tenth or below one-tenth compared to the amplitude of the ripple signal at the preset frequency in the first sampled signal S1, the amplitude attenuation of the remained signals outside the preset frequency in the second sampled signal S2 output by the filtering network is less than 20 percent of the amplitude of the signals outside the preset frequency in the first sampled signal S1, and the preset range of the phase delay between the second sampled signal S2 and the first sampled signal S1 is less than or equal to twenty degrees. However, these effects are not limited thereto, and different filtering effects may be obtained by adjusting the parameters or other settings of the filtering network. Therefore, in the embodiments of the feedback control circuit for the power converter disclosed in the first aspect of this application, the filtering effect of the filtering network depends on requirements for specific technical parameters of specific feedback control circuit for the power converter.

In order to facilitate further understanding the feedback control circuit disclosed in the first aspect of the present application, several embodiments of the feedback control circuit according to the first aspect of the present application are described further in detail below.

### First Embodiment

Please refer to the schematic diagram of the feedback control circuit shown in FIG. 8. FIG. 8 illustrates an example in which the power converter controlled by the feedback control circuit is an inverter, and the sampling network in the feedback control circuit samples the output of the inverter. Compared to the feedback control circuit as shown in FIG. 7, more specifically, the filtering network of the feedback control circuit shown in FIG. 8 is a passive notch filter. Other parts of the feedback control circuit are the same as those shown in FIG. 7, thus no repetitious details for those parts is given herein.

By means of rational design on parameters of the passive notch filter, the passive notch filter may provide greater attenuation to the ripple signal at the preset frequency and smaller phase delay, while it dose not have impact on the amplitude and phase of signals at other frequency bands. In this embodiment, the ripple signal at the preset frequency is a ripple signal at the switching level frequency.

The passive notch filter may comprise multiple notch branches being connected in parallel with each other, each branch comprising at least one notch inductor L and at least one notch capacitor C, while the notch capacitor C being connected in series with the notch inductor L. The structure of each notch branch is not limited to the enumerated one. There may be other components or other forms of connections. Each notch branch may be designed to filter out a ripple signal at a certain frequency. By means of appropriately designing the parameters, and reasonably choosing value for the notch inductor L and value for the notch capacitor C, the notch frequency point(s) may be set (for example, it may be set at switching frequency). For example, parameters for the notch inductor and/or the notch capacitor are selected such that the series resonant frequency is equal to the frequency of the ripple signal to be filtered.

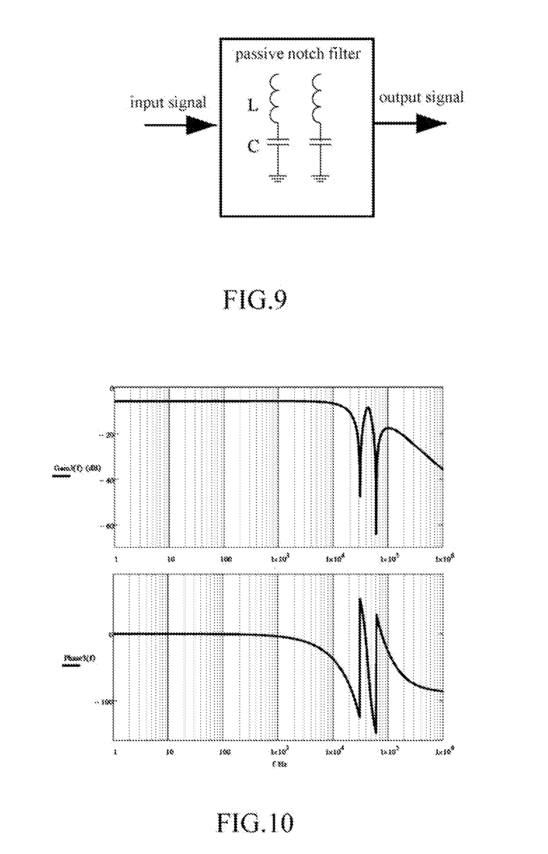

Please refer to the specific structure of a passive notch filter in FIG. 9. The passive notch filter comprises two notch branches being connected in parallel with each other. In view of the passive notch filter acting as the filtering network, in general the ripple signal at the preset frequency to be filtered out is ripple signal at switching level frequency. The following case in which the frequency of the ripple signal to be filtered out by the passive notch filter is switching frequency or twice the switching frequency will be further described. Each of the two notch branches being connected in parallel with each other comprises at least one notch inductor L and at least one notch capacitor C connected in series with the notch inductor L. And one of the two notch branches is used for filtering out the ripple signal at the switching frequency, while the other is used for filtering out the signal at a frequency twice the switching frequency. FIG. 10 shows Bode plots of the amplitude characteristics and the phase characteristics of the passive notch filter shown in FIG. 9. As shown in FIG. 10, the passive notch filter may filter out ripple signals at the switching frequency and at the frequency twice the switching frequency, and the phase shifts are relatively small.

### Second Embodiment

The second embodiment of a feedback control circuit is shown in FIG. 11. The components in the second embodiment are similar to that in the first embodiment, whereas the difference therebetween lies in that the filtering network in the feedback control circuit shown in the second embodiment is an active band-stop filter. Other parts of the feedback control circuit are the same as those shown in FIG. 7, thus no repetitious details for those parts will be given here. According to the characteristics of the active band-stop filter, the ripple signal at the preset frequency to be filtered out by this filter is the ripple signals at the switching level frequency and at frequencies close to the switching level frequency, while the sampled signals outside the stop band remain.

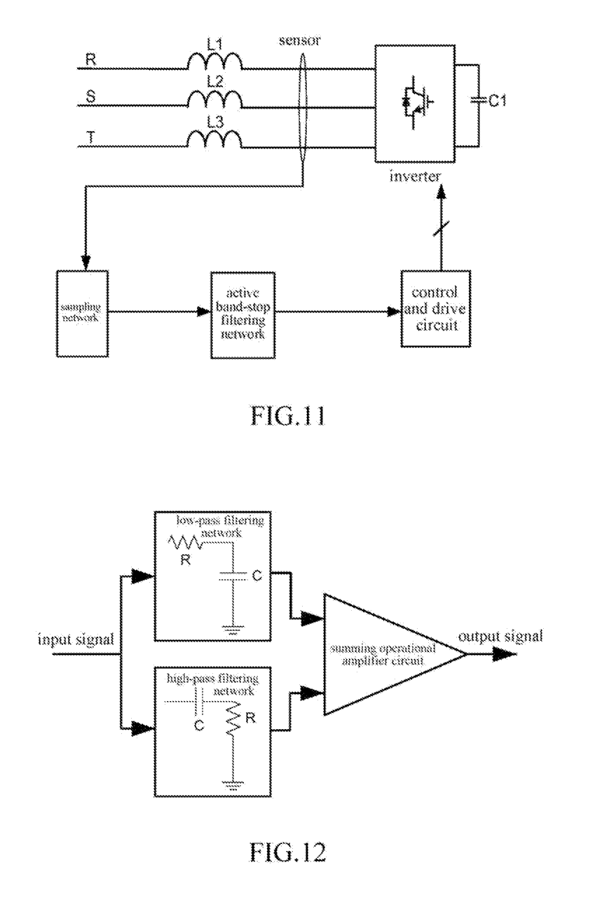

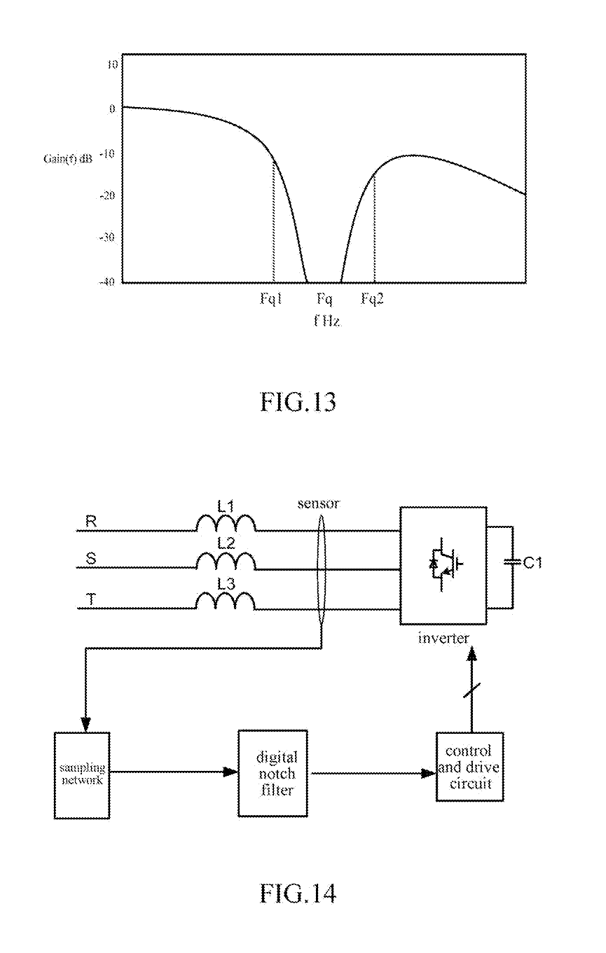

The stopband bandwidth of the active band-stop filter covers a range within which the ripple signals at the switching level frequency and at frequencies close to the switching level frequency fall. Please refer to FIG. 12, which depicts a schematic diagram of a specific structure of the active band-stop filter. The active band-stop filter comprises a low-pass filter, a high-pass filter and a signal processing circuit. The low-pass filter and high-pass filter receive simultaneously signals output by a sampling network, the signal processing circuit receives simultaneously both the output of the low-pass filter and the high-pass filter so as to performs appropriate processing before outputting them to the control and drive circuit. Wherein, the signal processing circuit may be a summing operational amplifier circuit. In FIG. 12, the cutoff frequency Fq1 of the low-pass filtering network may be designed to be lower than the switching frequency to be filtered out, while the cutoff frequency Fq2 of the high-pass filtering network may be designed to be higher than the switching frequency to be filtered out, and the summing operational amplifier circuit may be configured to increase the degree of attenuation of the frequency bands (Fq1 to Fq2) around the switching frequency in the sampled waveform, so as to achieve the effect of suppressing the ripples. As shown in the Bode plots of a band-stop filtering network in FIG. 13, the stopband center frequency is the switching frequency Fq, and the bandwidth is Fq2-Fq1. In the second embodiment, the structure of the active band-stop filter is not limited to the structure shown in FIG. 12.

FIG. 13 schematically shows the Bode plots of the active band-stop filter shown in FIG. 12. The active band-stop filters may filter out the ripple signals at switching frequency and at frequencies close to the switching frequency, as shown in FIG. 13. However, if necessary, it may also filter out ripple signal at the switching frequency and any ripple signals at frequencies being more than twice the switching frequency, that is, the cutoff frequency Fq1 of the low-pass filtering network may be designed to be lower than the lowest frequency among a number of different switching frequencies of the ripple signals to be filtered out, while the cutoff frequency Fq2 of the high-pass filtering network may be designed to be higher than the highest frequency among a number of different switching frequency of the ripple signals to be filtered out. Such a kind of active band-stop filter can be employed under a premise that the signal to be filtered out by the stop band of the active band-stop filter would not affect the normal operation or performance of the feedback control circuit.

### Third Embodiment

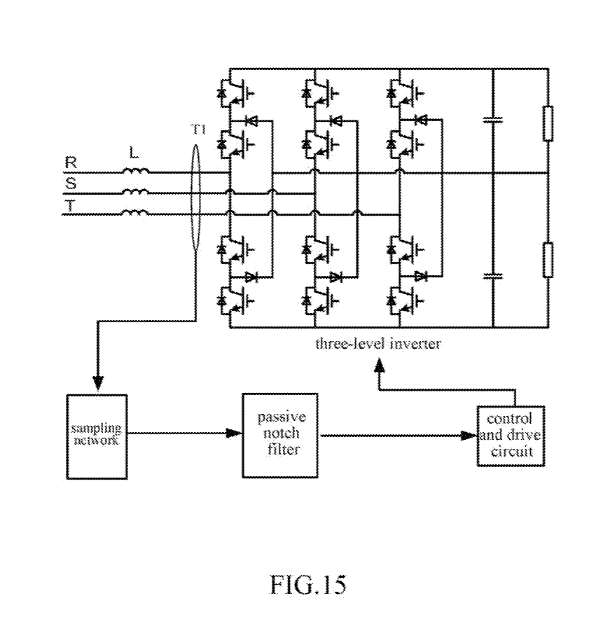

FIG. 14 shows the third embodiment of the feedback control circuit. The filtering network in the feedback control circuit shown in FIG. 14 is a digital notch filter. The digital notch filter is implemented by a technical process or method of converting a sampled signal or a series of values into another series of values. During design process of the digital notch filter, it is feasible to design an analog notch filter firstly, and then convert the analog notch filter into a digital notch filter with such as bilinear variational method.

The digital notch filter may be an IIR (infinite impulse response) digital filter or a FIR (finite impulse response) digital filter. Usually a digital notch filter comprises a digital band-stop filter unit, and the stopband bandwidth of the digital band-stop filter unit covers a range within which the ripple signal at the preset frequency falls. The ripple signal at the preset frequency include the ripple signal at the switching level frequency or at frequencies close to the switching level frequency, while the sampled signals outside the stopband would remain. Therefore, the operating principle of the digital notch filter is almost the same as that of the active band-stop filter, thus it will not be further described as it functions as a filtering network in the feedback control circuit for a power converter. The digital notch filter may also be set up based on actual demand, it is a routine operation process of a digital notch filter following its operation manual, and thus no repetitious details will be given here.

The second aspect of this application discloses a power converter system, comprising: a power converter for performing electrical energy conversion; and a feedback control circuit as disclosed in the first aspect, connected with the power converter, for regulating the input or output of the power converter.

In particular, referring to FIG. 15, in the power converter system, the input/output of the power converter is, after being regulated by the feedback control circuit, fed back to the power converter so as to control the power converter. The power converter controlled by the feedback control circuit may be a conventional two-level inverter, but also may be a multi-level inverter, such as a three-level inverter and so on. The power converter shown in FIG. 15 is a three-level inverter, and, for example, the three-level inverter is a PWM type power converter. The sampling network samples the output of the three-level inverter. In FIG. 15, the output current of the three-level inverter is sampled by the current sensor T1, and is converted by the sampling network to a voltage signal. A large number of high-frequency ripples contained in the voltage signal are filtered out by the filtering network (the filtering network is a passive notch filter according to the first embodiment as an example, but not limited thereto), thereby a signal of average current value that is actually output from the inverter is obtained. Such an obtained signal is used as the control feedback signal provided for the control and drive circuit to control the inverter. In other embodiments according to the second aspect of the present application, the sample object of the sampling network may also be a voltage. In general, for the control of a relative complex power converter system, correspondingly, the control accuracy of the feedback control circuit controlling the power converter in a power converter system is required more stringently. Therefore, the feedback control circuit of the power converter disclosed in the first aspect of the present application may be more suitable for a power converter system where higher control accuracy is required.

The power converter system as disclosed in the second aspect of the present application may be applied to active power filters, static var generators, uninterruptible power systems, inverters or switching power supplies etc., with the control accuracy of the system being improved.

In addition, in describing the specific content above, with respect to the ripple signals at frequencies having the preset values to be filtered out, however, it should be understood by those skilled in the art that the numerical range of the preset frequencies includes at least measurement error. In actual circuits, due to being affected by manufacturing technique, the components are not completely ideal components. Therefore, when the preset frequency is set to be a certain frequency, it is not an exact value in the mathematical sense, whereas the signal may be at a frequency close to this value or at frequencies having this value and around this value.

The present application is described above in various embodiments, but it should be noted that the above embodiments are merely for illustrating the technical solution of the present application, rather than limiting the scope of the present application. Although the present application is described in detail as far as possible by referencing to the above embodiments, however those skilled in the art should understand that modifications or equivalent replacements to the technical solution of the present application still belong to the substance and scope of the technical solution of the present application. As long as any improvements or variants to the present application exist, they should fall within the scope of the claims.

What is claimed is:

1. A feedback control circuit for a power converter, comprising:
a sampling network, configured to sample an input of the power converter or an output of the power converter, and output a first sampled signal;
a filtering network, configured to receive the first sampled signal, and output a second sampled signal; the filtering network filtering a ripple signal at a preset frequency out from the first sampled signal, so as to remain signals in the first sampled signal outside the preset frequency, while maintaining a phase delay of the second sampled signal relative to the first sampled signal within a preset range;
a control and drive circuit, configured to receive the second sampled signal, and regulate a control signal that is to be outputted from the control and drive circuit to the power converter in accordance with the second sampled signal.

2. The feedback control circuit according to claim 1, wherein the ripple signal at the preset frequency includes a ripple signal at a switching level frequency, or ripple signals at the switching level frequency and at frequencies close to the switching level frequency.

3. The feedback control circuit according to claim 1, wherein the filtering network is configured as a passive notch filter.

4. The feedback control circuit according to claim 3, wherein the passive notch filter comprises N notch branches connected in parallel with each other, where N is a natural number and is greater than or equal to 1.

5. The feedback control circuit according to claim 4, wherein each of the N notch branches comprises at least one notch inductor and at least one notch capacitor, and the notch inductor and the notch capacitor are connected in series.

6. The feedback control circuit according to claim 1, wherein the filtering network is an active band-stop filter, with a stopband bandwidth of the active band-stop filter covering a range within which the ripple signal at the preset frequency falls.

7. The feedback control circuit according to claim 6, wherein the active band-stop filter comprises a low-pass filter, a high-pass filter and a signal processing circuit, the low-pass filter and the high-pass filter performing band-stop filtering to the first sampled signal and then outputting the first sampled signal to the signal processing circuit, and the signal processing circuit outputting the second sampled signal to the control and drive circuit.

8. The feedback control circuit according to claim 7, wherein the signal processing circuit is configured as a summing operational amplifier circuit.

9. The feedback control circuit according to claim 1, wherein the filtering network is configured as a digital notch filter comprising a digital band-stop filter unit, with a stopband bandwidth of the digital band-stop filter unit covering a range within which the ripple signal at the preset frequency falls.

10. The feedback control circuit according to claim 9, wherein the digital notch filter is configured as an infinite impulse response digital filter or a finite impulse response digital filter.

11. The feedback control circuit according to claim 1, wherein the control and drive circuit comprises a PWM control unit and a drive circuit, the PWM control unit receiving the second sampled signal, performing PWM modulation to the second sampled signal, and feeding the modulated second sampled signal back to the power converter via the drive circuit.

12. A power converter system, comprising:
a power converter, configured to perform electrical energy conversion; and
a feedback control circuit according to claims 1, configured to be connected to the power converter, and regulate an input of the power converter or an output of the power converter.

13. The power converter system according to claim 12, wherein the power converter is configured as a PWM-type power converter.

14. The power converter system according to claim 12, wherein the power converter is configured as an inverter.

15. The power converter system according to claim 14, wherein the inverter is configured as a multi-level inverter.

16. The power converter system according to claim 12, wherein the power converter system is applied to an active power filter or a static var generator.
